(19) United States
(12) Patent Application Publication
(10) Pub. No.: US 2019/0343068 A1
(43) Pub. Date: Nov. 14, 2019

(54) BOTTOM LOADING PET CARRIER

(71) Applicant: Debra DePaulis, Hollis, NH (US)

(72) Inventor: Debra DePaulis, Hollis, NH (US)

(21) Appl. No.: 16/319,047

(22) PCT Filed: Jul. 20, 2017
(86) PCT No.: PCT/US2017/042984

§ 371 Date: Jan. 18, 2019

Related U.S. Application Data
(60) Provisional application No. 62/364,373, filed on Jul. 20, 2016.

(51) Int. Cl. A01K 1/02

(52) U.S. Cl. CPC A01K 1/0245

(57) ABSTRACT

A pet carrier having a removable bottom allows a shell to be placed over the pet from above, after which the bottom is slid beneath the shell and secured thereto. The shell can comprise a flexible cover such as a canvas cover removably attached to a stiff frame. In embodiments, the cover can be removed from the frame for washing and storage, and/or the frame can be folded and/or disassembled for storage. The bottom can be secured to the shell by hook-and loop attachment of folded straps inserted through loops fixed to the bottom, or the shell can be attached by pegs or quarter-turn studs that are tethered to the shell and inserted through holes provided in a lower rim of the shell and in the bottom. Mesh ventilation openings and/or a removable front panel attached by a zipper can also be provided.

### RELATED APPLICATIONS

This application claims the benefit of U.S. Provisional Application No. 62/364,373, filed Jul. 20, 2016, which is herein incorporated by reference in its entirety for all purposes.

### FIELD OF THE INVENTION

The invention relates to pet-related apparatus and methods, and more particularly to pet carriers.

### BACKGROUND OF THE INVENTION

Ownership of a pet, such as a cat, dog, bird, etc., can be a very rewarding and enjoyable experience. However, pet ownership also confers certain responsibilities on the pet owner.

In addition to feeding and housing a pet, a pet owner sometimes also finds it necessary to transport the pet to a location away from the home, for example if a trip to the veterinarian is needed, or if the pet is to travel with its owner or to temporarily to reside with a sitter or boarding facility while the owner is away.

While pets, especially dogs, can sometimes be simply carried, or transported using only a leash, in many other situations it is necessary or desirable to transport a pet in pet carrier, which serves as a portable, ventilated container or cage for the pet.

Pet carriers are typically sturdy and safe, both for the pet and for the owner, and are usually well secured against accidental release of the pet while in transit. With reference to FIG. 1, a pet carrier 100 will typically include a housing 102, a handle 104, plentiful ventilation 106, and a hinged door 108 that covers an opening 110 in a side of the housing 102. Once the pet is in the carrier 100, the door 108 is held shut by a secure latch 112.

This arrangement is simple and highly convenient for the pet owner. However, it is often far from attractive to the pet. Indeed, it can be contrary to the instincts of most pets to willingly enter a highly confined space through a relatively small opening, such that even a normally well-behaved pet often resists entry into the carrier. And without the cooperation of the pet, attempts to place the pet within the carrier can be very difficult and frustrating, for both the pet and the owner.

Furthermore, pets often come to associate a carrier with unpleasant experiences, such as a trip to a veterinarian or pet groomer, which can cause the pet to be even more vehemently opposed to entering the carrier.

What is needed, therefore, is a pet carrier into which a pet can be easily and safely placed, with little or no requirement for cooperation by the pet.

### SUMMARY OF THE INVENTION

A pet carrier is disclosed that enables placement of a pet therein while requiring little or no cooperation by the pet. Instead of requiring that the pet enter the carrier through a small door in a side of the carrier, the disclosed pet carrier includes a removable bottom that allows the shell of the carrier to be placed over the pet from above, typically while the pet is being distracted by its owner, or is otherwise looking forward rather than upward. Once the shell is in place over the pet, the bottom is carefully slide beneath the shell and secured thereto.

The bottom of the disclosed carrier can be secured to the shell by any means known in the art. For example, a flange can be provided around the rim of the shell and can include clearance holes through which fasteners can be vertically inserted and screwed or anchored to the underlying bottom. In other embodiments, clamps, clips, or latches are clipped or otherwise latched so as to connect the bottom to the lower rim of the shell.

In still other embodiments, the lower rim of the shell surrounds the outer perimeter of the bottom, so that the rim of the shell is flush with the lower surface of the bottom, and attachment is provided by insertion of pegs laterally through clearance holes in the outer shell rim and into holes provided in the outer rim of the bottom. The pegs can be inserted on only two opposing sides of the carrier, or on all four sides of the carrier. The pegs can be individually inserted, or can be affixed to backing strips and inserted in groups. Once inserted, the pegs can be held in place by latches, springs, or any other attachment means known in the art. Safety straps can be provided to prevent unintentional escape of the pet in the event that the primary attachment mechanism fails.

A first general aspect of the present invention is a pet carrier that includes a shell having four sides and a top, a carrier bottom, and an attachment mechanism suitable for attaching said carrier bottom to a lower rim of said shell.

In embodiments, the shell includes a flexible cover attached to a supporting frame. In some of these embodiments the cover can be removed from the frame for at least one of washing and folded storage. And in some of these embodiments, the frame can be at least one of folded and disassembled so that it can be stored in a flat configuration.

In any preceding embodiment, the lower rim of the shell can include a horizontal flange, said flange being penetrated by vertical clearance holes; and the attachment mechanism can include vertical fasteners configured for insertion through the vertical clearance holes and attachment to the carrier bottom.

Or, the carrier bottom can be configured to be surrounded by the lower rim of the shell, the carrier bottom can include a plurality of horizontal attachment holes provided in at least two opposing vertical sides of the carrier bottom the lower rim of the shell can include a plurality of clearance holes configured for alignment with the attachment holes when the carrier bottom is surrounded by the lower rim of the shell, and the attachment mechanism includes a plurality of pegs configured for insertion through the clearance holes and into the attachment holes. In some of these embodiments, the pegs are quarter-turn studs. In either of these embodiments, the pegs can be tethered to the shell. In some of these embodiments the pegs are affixed to backing strips, a plurality of the pegs being affixed to each backing strip and configured for simultaneous insertion through the clearance holes and into the attachment holes.

In some of these embodiments, the attachment mechanism includes springs that pull the backing strips toward the clearance and attachment holes. In other of these embodiments the attachment mechanism includes latches that secure the backing strips to the lower rim of the shell when the pegs are inserted through the clearance holes and into the attachment holes.

In any of the embodiments that includes backing strips, the backing strips can be attached to the shell by flexible fabric strips.

In any of the preceding embodiments, the attachment mechanism can include a plurality of straps that are attached to the shell and are removably attachable to fasteners attached to the carrier bottom. In some of these embodiments the straps include hook-and-loop fastening that enable attachment to the fasteners by passing lower portions of the straps through loops provided by the fasteners, folding the lower portions so that they overlap upper portions of the straps, and attaching the lower portions to the upper portions using the hook-and-loop fastening. In other of these embodiments the straps are attachable to the fasteners by strap-and-buckle fastening.

In any of the preceding embodiments, the shell can include a panel that can be opened for entry and/or removal of a pet. And in some of these embodiments the panel can be opened and closed by a zipper.

Another general aspect of the present invention is a method of inserting a pet into a pet carrier, which includes providing a pet carrier according to any of the embodiments described above, lowering the shell over the pet, lifting one side of the lower rim and sliding the carrier bottom under the shell, and using the attachment mechanism to secure the carrier bottom to the shell.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a perspective view of a prior art pet carrier;

FIG. 2 is a perspective view of a pet carrier in an embodiment of the present invention in which the pegs are attached to backing strips attached to the shell by fabric strips and held in place by springs;

FIG. 3A is a perspective view showing the shell of FIG. 2 positioned over a pet;

FIG. 3B is a perspective view showing the shell of FIG. 3A lowered over the pet;

FIG. 3C is a perspective view showing the bottom of the embodiment of FIG. 3B being slid beneath the shell;

FIG. 3D is a perspective view showing the carrier of FIG. 3C with the bottom inserted below the shell;

FIG. 3E is a perspective view showing the carrier of FIG. 3D with the pegs inserted into the holes and held in place by the springs;

FIG. 4A is a perspective view of an embodiment of the present invention similar to FIG. 2 except that the backing strips are held in place by latches, the embodiment being illustrated with the bottom removed;

FIG. 4B is a perspective view of the embodiment of FIG. 4A shown with the bottom attached to the shell;

FIG. 5A is a cross-sectional expanded partial view of a clearance hole aligned with an attachment hole in an embodiment of the invention;

FIG. 5B is a cross-sectional expanded partial view similar to FIG. 5A but showing a peg attached to a backing strip and inserted through the clearance hole and into the attachment hole;

FIG. 5C is a cross-sectional expanded partial view showing a safety strap attaching the bottom to the shell at a corner of an embodiment of the present invention;

FIG. 6 is a perspective view of a frame that is included in an embodiment where the shell comprises a flexible cloth cover removably supported by a frame;

FIG. 7A is a bottom view of the flexible cover of the embodiment of FIG. 6 shown before attachment of the front and back panels of the flexible cover;

FIG. 7B is a top view of the flexible cover of FIG. 7A;

FIG. 8A is a front perspective view of the shell comprising the completed cover of FIGS. 7A and 7B assembled with the frame of FIG. 6;

FIG. 8B is a rear perspective view of the assembled shell of FIG. 8A;

FIG. 9 is a top view of a cloth cover that can be assembled with a rigid panel to form the base of the embodiment of FIGS. 6-8B;

FIG. 10 is an exploded view of the cover, frame, and base of the embodiment of FIGS. 6-10;

FIG. 11 is a front perspective view of the assembled shell and base of the embodiment of FIGS. 6-11;

FIG. 12A is a cross-sectional close-up side view of a base and quarter-turn stud illustrating an attachment mechanism in an embodiment of the invention, shown with the base detached from the shell; and

FIG. 12B is a cross-sectional close-up side view of the base and quarter-turn stud of FIG. 12A, shown with the base attached to the shell.

### DETAILED DESCRIPTION

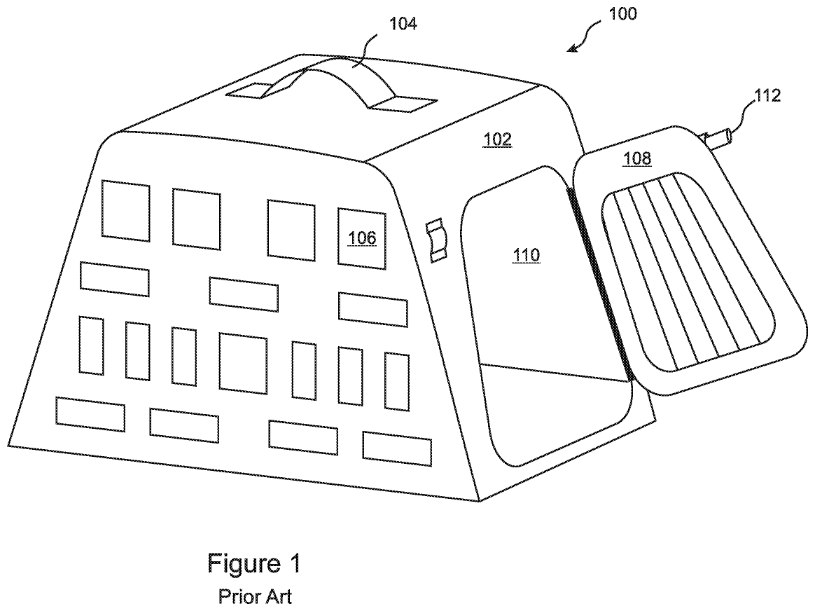

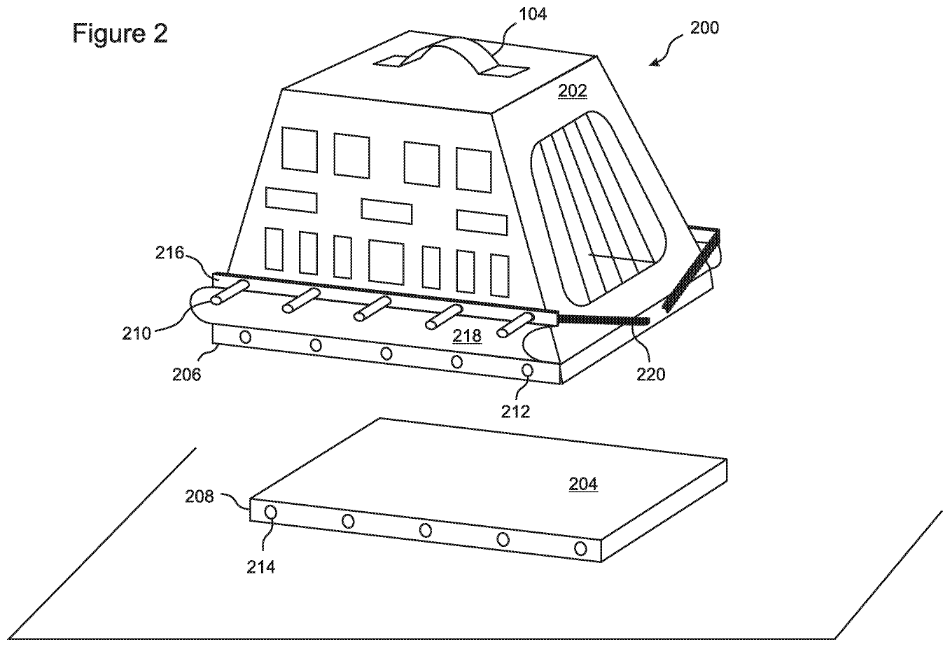

The present invention is a pet carrier that enables placement of a pet therein while requiring little or no cooperation by the pet. The typical prior art carrier, such as the example shown in FIG. 1, requires that the pet enter the carrier 100 through a small door opening 110 in a side of the housing 102. With reference to FIG. 2, the disclosed pet carrier 200 includes a shell 202 and a removable bottom 204. This arrangement allows the shell 202 to be placed over the pet from above, perhaps while the pet is being distracted by its owner or otherwise looking forward rather than upward.

Once the shell 202 is in place, the bottom 204 is carefully slide beneath the shell and secured thereto.

The bottom 204 can be secured to the shell 202 by any means known in the art. For example, a flange can be provided around the rim 206 of the shell 202 and can include clearance holes through which fasteners can be vertically inserted and screwed or anchored to the underlying bottom 204. In other embodiments, clamps, clips, or latches affix the bottom 204 to the rim 206 of the shell 202 at spaced-apart locations about the outer edge 208 of the bottom 204.

In the embodiment of FIG. 2, the lower rim 206 of the shell 202 is large enough to surround the outer perimeter 208 of the bottom section 204. In this embodiment, attachment of the bottom 204 to the shell 202 is provided by insertion of pegs 210 laterally through clearance holes 212 in the shell rim 206 and into holes 214 provided in the outer rim 208 of the bottom section 202. In various embodiments, the pegs 210 are inserted on only two opposing sides of the shell 202, as shown in FIG. 2, while in other embodiments they are inserted on all four sides of the shell 202.

The pegs 210 can be individually inserted, or as shown in FIG. 2 they can be affixed to backing strips 216 and inserted in groups. In the embodiment of FIG. 2, the backing strips 216 that hold the pegs 210 are attached to the shell 202 by a flexible strip of fabric 218 and held in place by springs 220. The springs 220 in the embodiment of FIG. 2 function to hold the pegs 210 and backing strip 216 out of the way when the shell 202 and bottom 204 are separated, as well as holding the pegs 210 and backing strip 216 in place when the shell 202 is attached to the bottom 204.

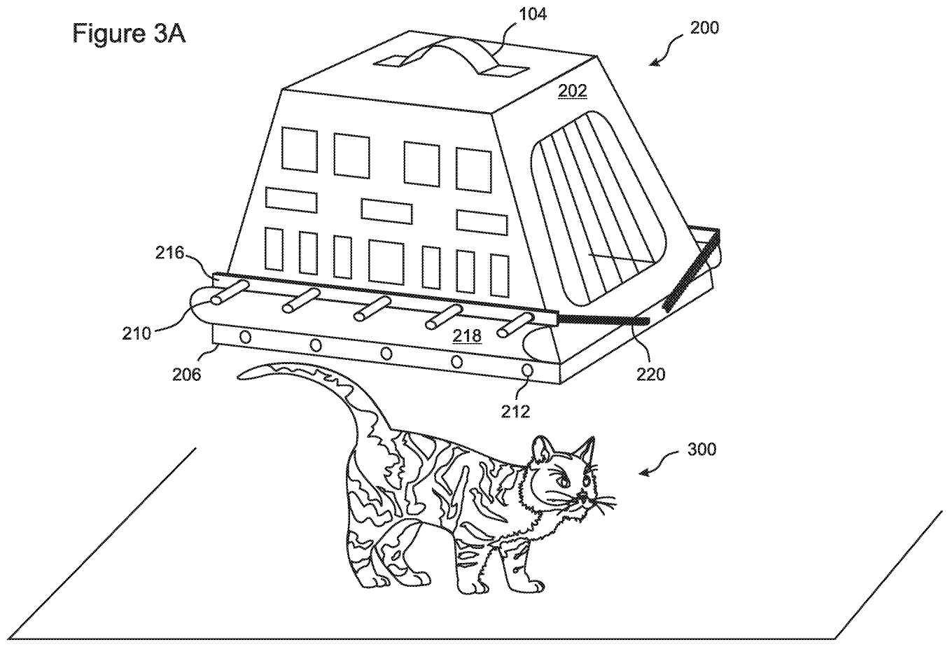

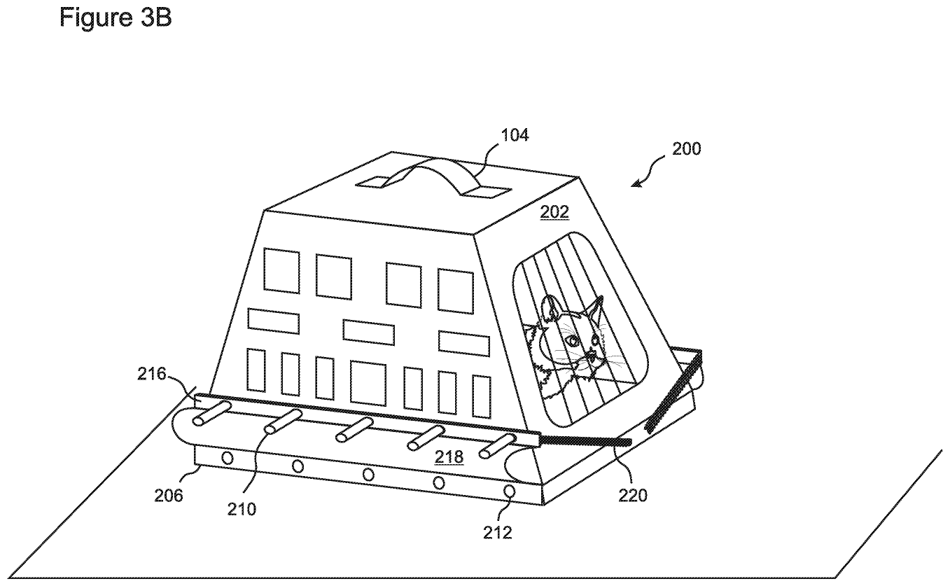

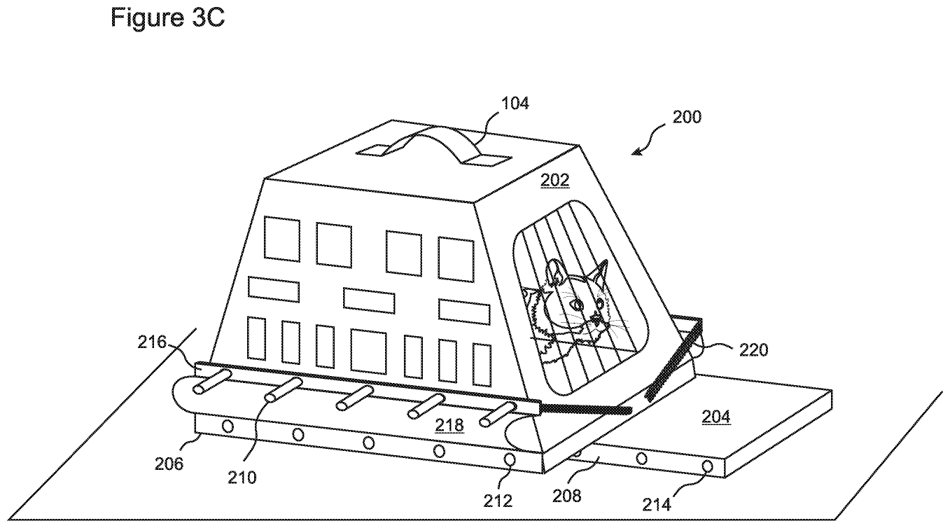

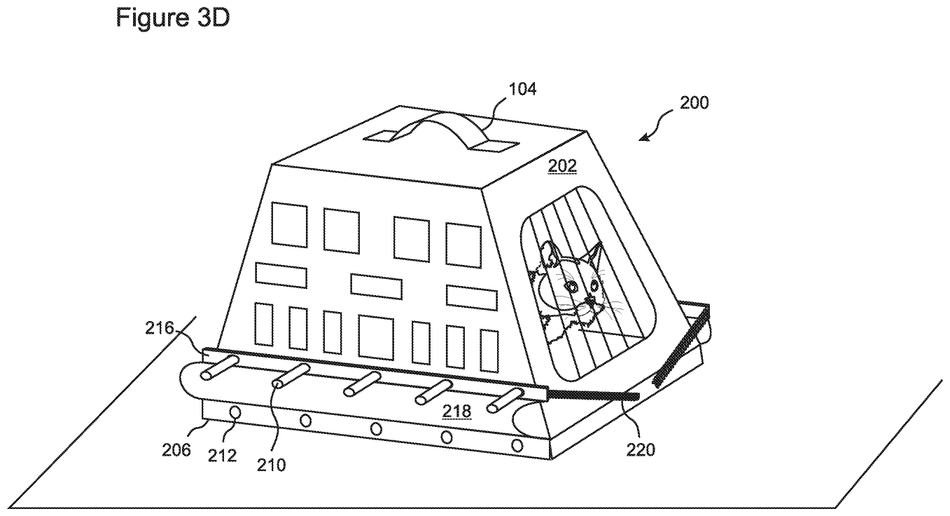

FIGS. 3A-3E illustrates the method by which a pet 300 can be placed within the embodiment of FIG. 2. In FIG. 3A, the shell 202 is positioned over the pet 300, for example while the pet's attention is directed at something in the distance, and not upward toward the shell 202. At this point, the springs 220 hold the backing strips 216 and pegs 210 out of the way. In FIG. 3B, the shell 202 has been placed over the pet 300. In FIG. 3C, the front edge of the shell 202 is slightly lifted, while the bottom 204 is slid beneath the shell 202. Of course, the pet 300 has no choice but to step up onto the bottom 204. In FIG. 3D, the bottom 204 has been inserted entirely beneath the shell 202, and the shell 202 has been lowered so that outer rim 206 of the shell 202 surrounds, and is adjacent to, the outer rim 208 of the bottom 204.

Finally, in FIG. 3E, the pegs 210 are inserted through the holes 212, in the rim 206 of the shell 202 and into the holes 214 in the bottom 204, and the backing strips 216 are secured in place by the springs 220.

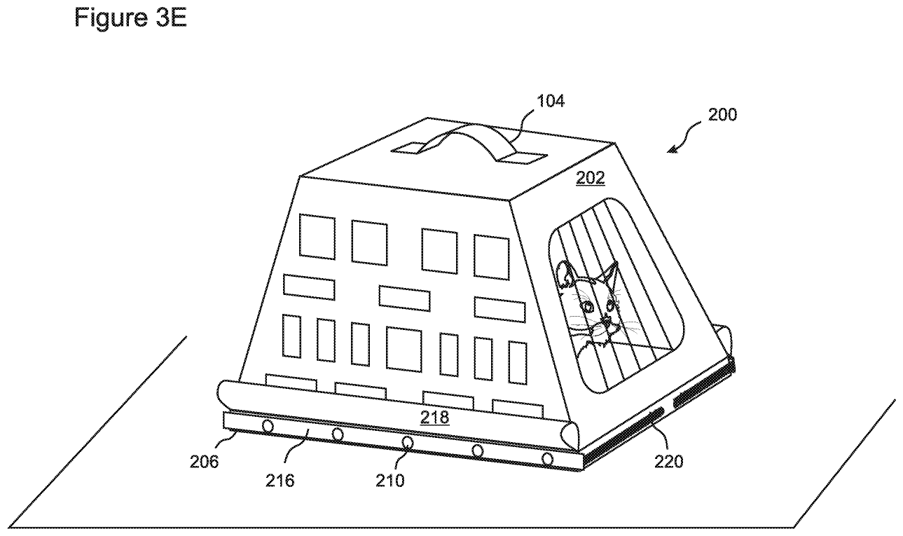

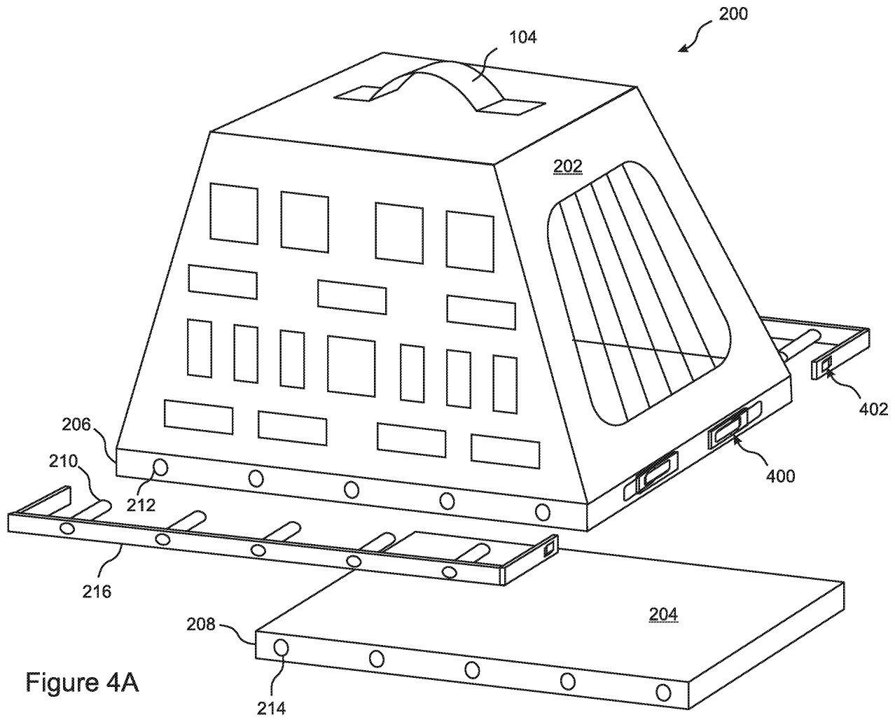

FIGS. 4A and 4B illustrate an embodiment similar to the embodiment of FIG. 2, but in which the backing strips 216 that hold the pegs 210 are attached to the shell 202 by latches 400, 402. In FIG. 4A the pegs 210 and backing strips 216 have been retracted and the bottom 204 has been removed. In FIG. 4B the bottom 204 is attached to the shell 202 by the pegs 210 and the latches 218, 220 are secured.

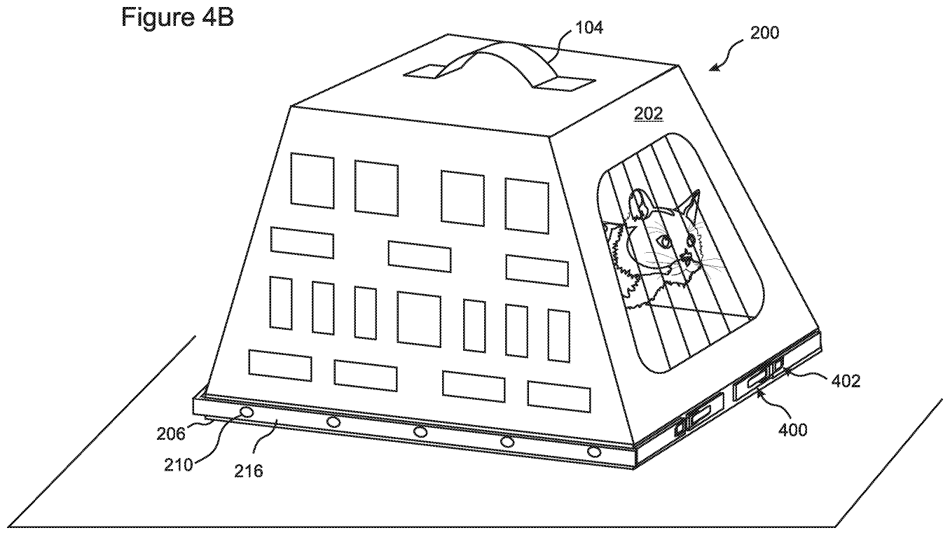

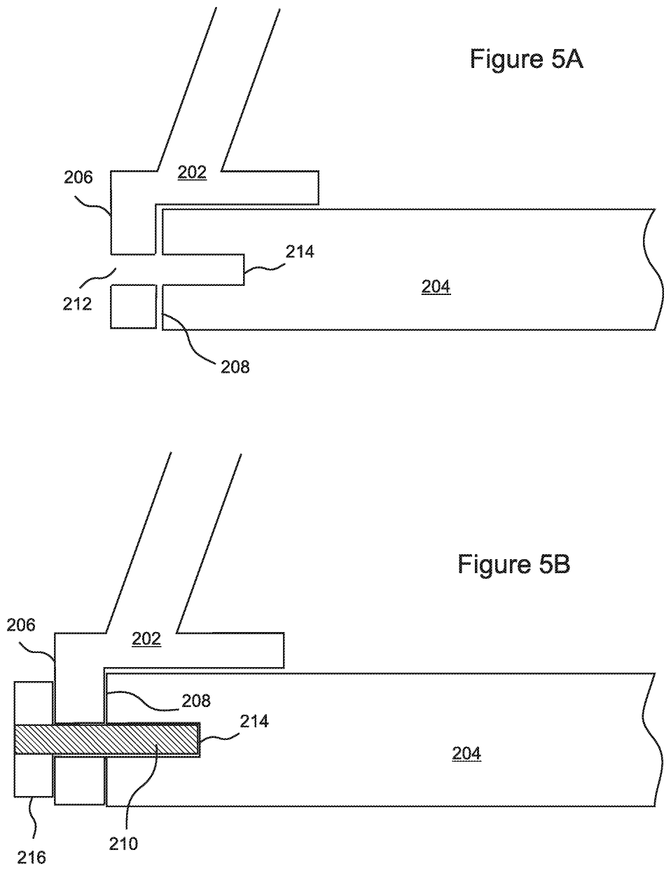

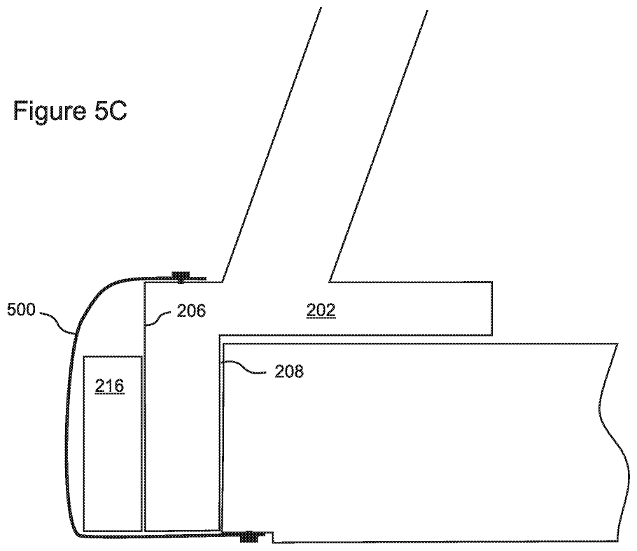

FIG. 5A is a cross-sectional view of the aligned edge 208 of the bottom 204 and outer rim 206 of the shell 202 as they are configured, for example, in FIG. 3D. In particular, one of the holes 212 in the outer shell rim 206 is shown to be aligned with a hole 214 in the bottom 204. FIG. 5B illustrates the same cross section in the configuration of FIG. 3E, showing a peg 210 inserted in the aligned holes 212, 214.

With reference to FIG. 5C, safety straps 500 can be provided to prevent unintentional escape of the pet in the event that the primary attachment mechanism fails.

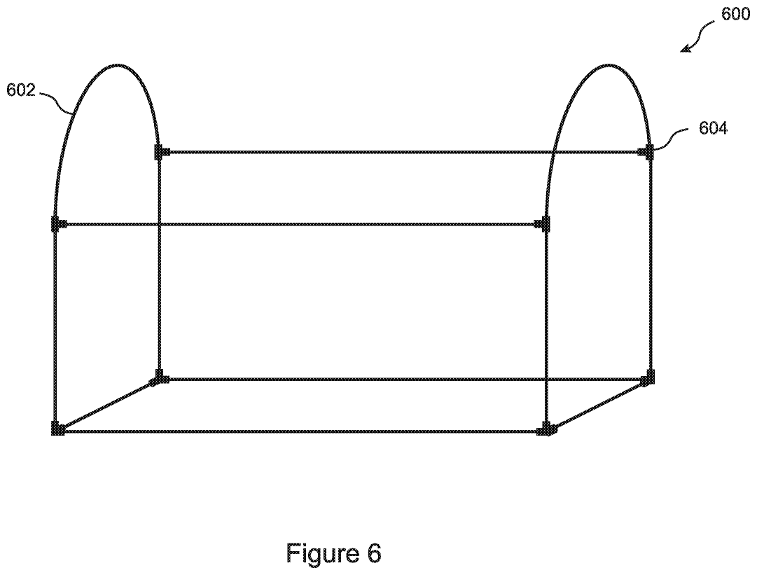

FIGS. 6 through 11 illustrate an embodiment in which the shell 202 of the pet carrier is flexible and can be collapsed for convenient storage. As shown in FIG. 6, the shell 202 in the illustrated embodiment includes a frame 600 constructed from substantially rigid rods 602 joined together by connectors 604. In embodiments, the rods 602 are stiff but bendable plastic rods, and/or flexible aluminum rods or bars. In the embodiment of FIG. 6, the frame 600 can be collapsed by disassembly of the rods 602 from the joints 604.

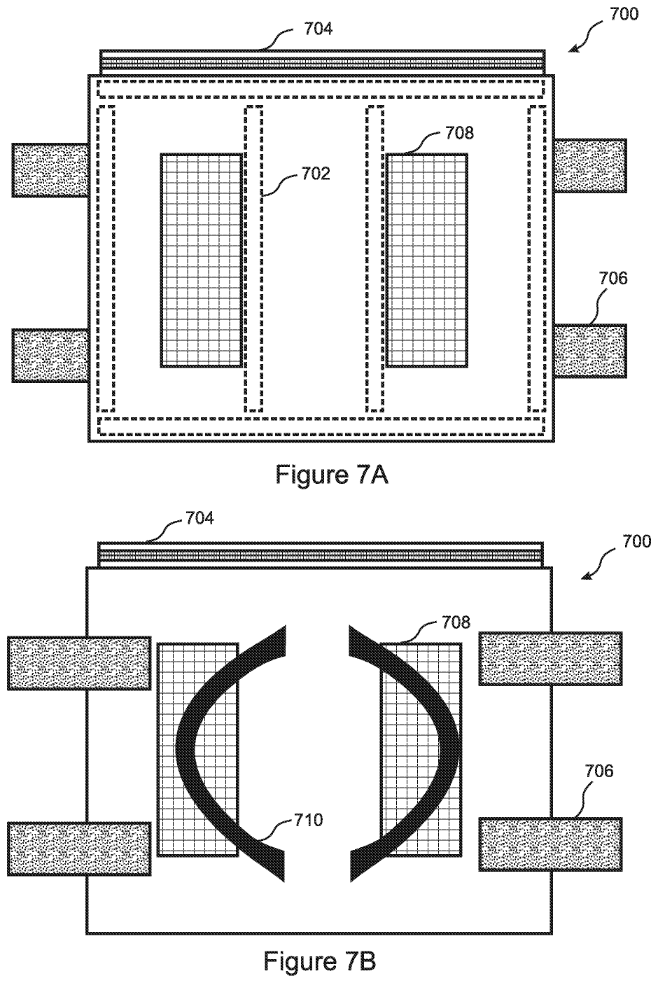

FIG. 7A is a bottom view of a fabric cover 700 that is attached to the frame 600 to form the shell 202. In embodiments, the cover fabric is a double layer of canvas. The cover 700 includes pockets 702 into which the rods 602 are inserted. A zipper 704 is included for attachment of a front panel 800, which forms a door. A rear panel 802 has not yet been sewn to the cover as it is illustrated in FIG. 7. The cover 700 further includes attachment straps 706 for attachment of the cover 700 to the base 800. In embodiments, the straps 706 include hook-and-loop attachment features. The straps 706, for example, can be 1.5 inches wide. Mesh openings 708 can also be included for air circulation, and to allow a pet to see out from the carrier. FIG. 7B is a top view of the cover 700 of FIG. 7A. In this view it can be seen that the cover includes carrying handles 710.

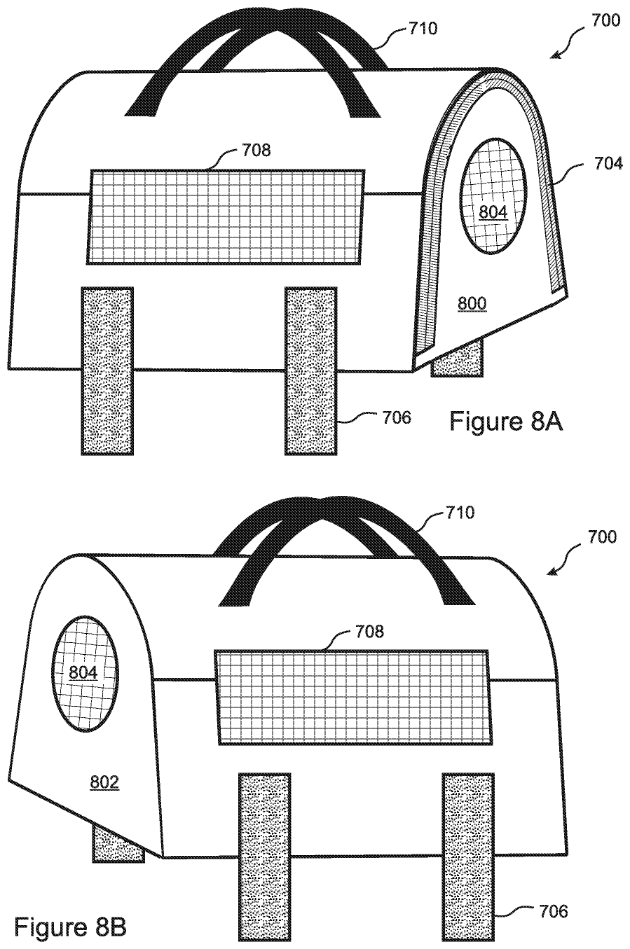

FIGS. 8A and 8B are front and rear perspective views, respectively, of the cover 700 of FIGS. 7A and 7B, where the front panel 800 has been sewn to the cover and closed by the zipper 704, and the rear panel 802 has been sewn in place. Both the front 800 and rear 802 panels include mesh ventilation openings 804. In embodiments, the cover 700 is washable.

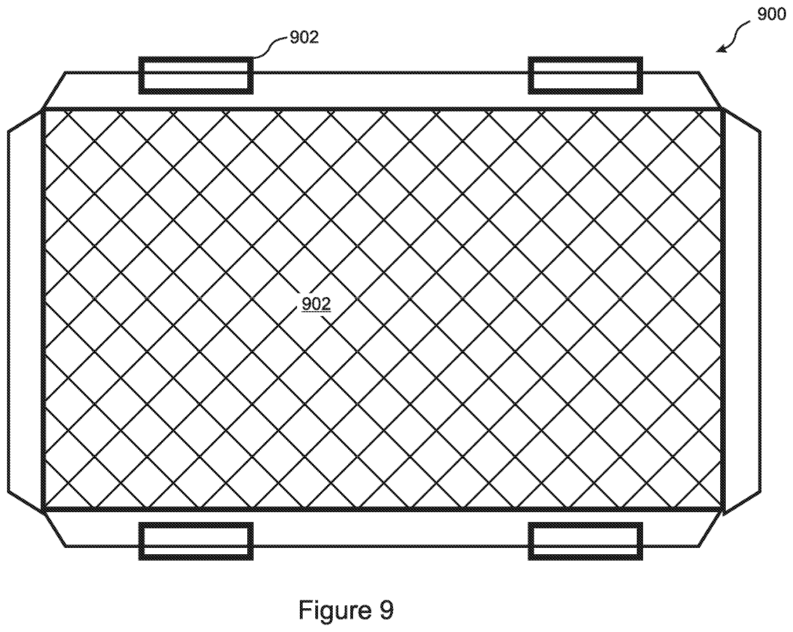

FIG. 9 is a top view of the base 900 that is included in the embodiment of FIGS. 6-11. In embodiments the base can have, for example, dimensions of 12 inches by 18 inches, or 16 inches by 20 inches. In the illustrated embodiment, the top of the base 900 is covered by a soft, quilted cover 902, while the bottom is covered by a smooth nylon fabric (not shown). Loops or fasteners 902 are provided along the sides of the base, for engagement with the straps 706 of the cover 700. In embodiments, four metal fasteners 902 are provided (two on each side), each of which is 1.5 inches wide.

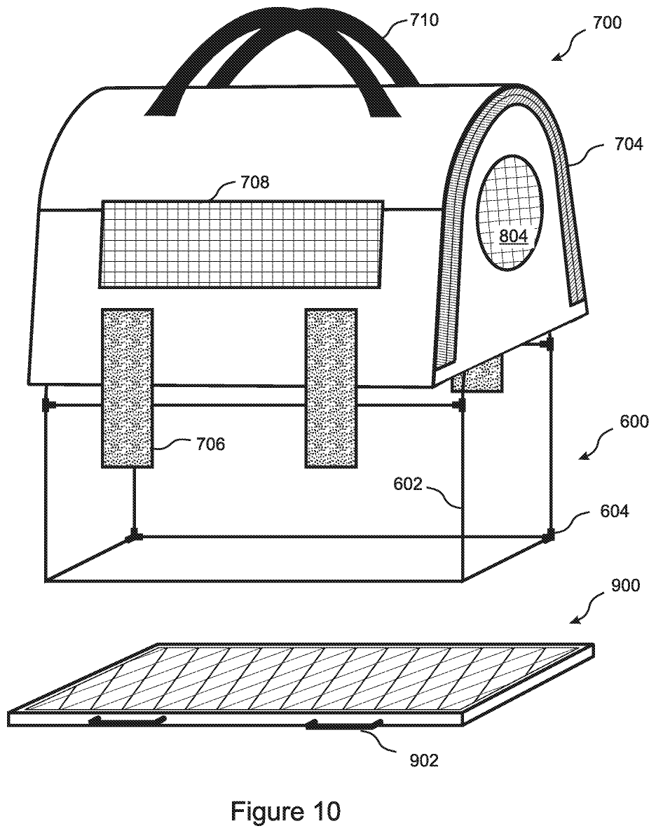

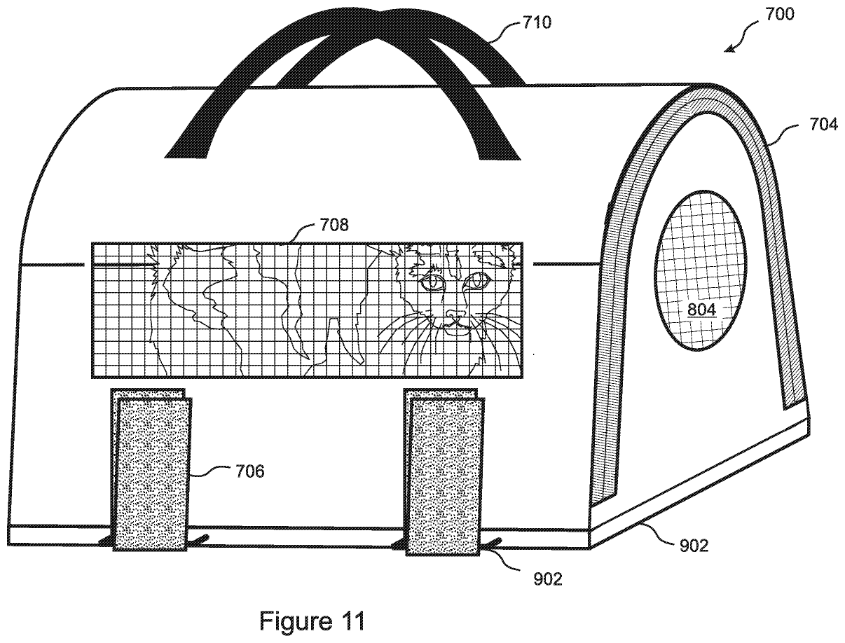

FIG. 10 is, essentially, an exploded view showing the cover 700 positioned above the frame 600, both of which are positioned above the base 900. In use, when placing a pet into the carrier, the cover 700 would be assembled with the frame 600. The assembled cover 700 and frame (forming the shell 202) would then be placed over the pet, and the base 900 would be slid under the shell 202, where it could be attached to the cover 700 using the straps 706. The resulting assembly is shown in FIG. 11. As an alternative, a cooperative pet can be inserted and/or removed by removing the front panel 800 using the zipper 704.

As an alternative to hook-and loop fastening, similar embodiments include strap-and-buckle fastening, while still other embodiments include buttons and/or snaps to fasten the straps 706 to the loops 902. Other attachment mechanisms as are known in the art are also included within the scope of the present invention.

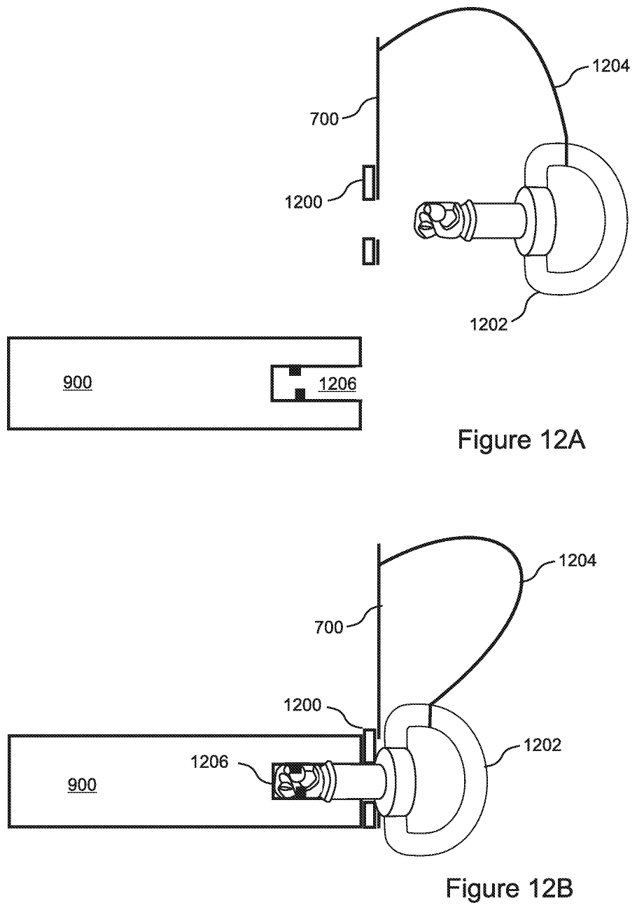

FIGS. 12A and 12B are cross-sectional side views of a portion of a base 900 in an embodiment similar to FIGS. 6-11, but where the cover 700 is fastened to the base 900 by quarter-turn studs 1202. In this embodiment the frame 600 includes stiff side panels 1200 that are at least as wide as the thickness of the base 900, and are penetrated by holes that are compatible with the studs 1202. Compatible holes 1206 are also provided in the base 900. In the illustrated embodiment, the studs 1202 are attached by tethers 1204 to the cover 700 so that they are available when needed. In embodiments, the attachment of the tether 1204 is releasable, so that the cover 700 can be washed with the studs 1206 detached. FIG. 12A illustrates the embodiment with the stud 1202 and cover 700 removed, while FIG. 12B shows the assembled base 900, cover 700 with strip 1200, and stud 1206.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application.

The invention illustratively disclosed herein suitably may be practiced in the absence of any element which is not specifically disclosed herein and is not inherently necessary. However, this specification is not intended to be exhaustive. Although the present application is shown in a limited number of forms, the scope of the invention is not limited to just these forms, but is amenable to various changes and modifications without departing from the spirit thereof. One or ordinary skill in the art should appreciate after learning the teachings related to the claimed subject matter contained in the foregoing description that many modifications and variations are possible in light of this disclosure. Accordingly, the claimed subject matter includes any combination of the above-described elements in all possible variations thereof, unless otherwise indicated herein or otherwise clearly contradicted by context. In particular, the limitations presented in dependent claims below can be combined with their corresponding independent claims in any number and in any order without departing from the scope of this disclosure, unless the dependent claims are logically incompatible with each other.

1. A pet carrier, comprising:
a shell having four sides and a top;
a carrier bottom; and
an attachment mechanism suitable for attaching said carrier bottom to a lower rim of said shell.

2. The pet carrier of claim 1, wherein the shell includes a flexible cover attached to a supporting frame.

3. The pet carrier of claim 2, wherein the cover can be removed from the frame for at least one of washing and folded storage.

4. The pet carrier of claim 2, wherein the frame can be at least one of folded and disassembled so that it can be stored in a flat configuration.

5. The pet carrier of claim 1, wherein:
the lower rim of the shell includes a horizontal flange, said flange being penetrated by vertical clearance holes; and
the attachment mechanism includes vertical fasteners configured for insertion through the vertical clearance holes and attachment to the carrier bottom.

6. The pet carrier of claim 1, wherein:
the carrier bottom is configured to be surrounded by the lower rim of the shell;
the carrier bottom includes a plurality of horizontal attachment holes provided in at least two opposing vertical sides of the carrier bottom;
the lower rim of the shell includes a plurality of clearance holes configured for alignment with the attachment holes when the carrier bottom is surrounded by the lower rim of the shell; and
the attachment mechanism includes a plurality of pegs configured for insertion through the clearance holes and into the attachment holes.

7. The pet carrier of claim 6, wherein the pegs are quarter-turn studs.

8. The pet carrier of claim 6, wherein the pegs are tethered to the shell.

9. The pet carrier of any of claim 8, wherein the pegs are affixed to backing strips, a plurality of the pegs being affixed to each backing strip and configured for simultaneous insertion through the clearance holes and into the attachment holes.

10. The pet carrier of claim 9, wherein the attachment mechanism includes springs that pull the backing strips toward the clearance and attachment holes.

11. The pet carrier of claim 9, wherein the attachment mechanism includes latches that secure the backing strips to the lower rim of the shell when the pegs are inserted through the clearance holes and into the attachment holes.

12. The pet carrier of claim 9, wherein the backing strips are attached to the shell by flexible fabric strips.

13. The pet carrier of claim 1, wherein the attachment mechanism includes a plurality of straps that are attached to the shell and are removably attachable to fasteners attached to the carrier bottom.

14. The pet carrier of claim 13, wherein the straps include hook-and-loop fastening that enable attachment to the fasteners by passing lower portions of the straps through loops provided by the fasteners, folding the lower portions so that they overlap upper portions of the straps, and attaching the lower portions to the upper portions using the hook-and-loop fastening.

15. The pet carrier of claim 13, wherein the straps are attachable to the fasteners by strap-and-buckle fastening.

16. The pet carrier of claim 1, wherein the shell includes a panel that can be opened for entry and/or removal of a pet.

17. The pet carrier of claim 16, wherein the panel can be opened and closed by a zipper.

18. A method of inserting a pet into a pet carrier, comprising:
providing a pet carrier according to claim 1;
lowering said shell over said pet;
lifting one side of said lower rim and sliding the carrier bottom under the shell; and
using the attachment mechanism to secure the carrier bottom to the shell.
